(19) United States
(12) Patent Application Publication
(10) Pub. No.: US 2005/0213337 A1
(43) Pub. Date: Sep. 29, 2005

(54) Worklight with tripod cradle

(76) Inventors: Wade Lee, Danville, CA (US); Donald R. Sandell, San Jose, CA (US)

Correspondence Address: ELLIOT B. ARONSON, 5001 HARBORD DRIVE, OAKLAND, CA, 94618, US

(21) Appl. No.: 11/158,703

(22) Filed: Jun. 21, 2005

Related U.S. Application Data
(60) Provisional application No. 60/581,952, filed on Jun. 21, 2004.

(51) Int. Cl. F21S 2/00

(52) U.S. Cl. 362/382

(57) ABSTRACT

a worklight assembly having a base that is formed for holding a portable collapsible support stand (commonly referred to as a tripod) so that the stand may readily be carried, transported and stored with the worklight as a unit. Briefly, the base is formed to include a cradle that is sized and disposed to receive the support stand in its collapsed configuration. In one embodiment a continuous member such as a continuous length of tubing is bent into a framework for providing the cradle. The ends of the continuous tubing may also be formed to provide feet and the worklight head or heads may be mounted on the framework, for example, on a cross bar stretching across the feet.

This application claims the benefit of provisional application No. 60/581,952 filed Jun. 21, 2004.

### BACKGROUND OF THE INVENTION

The present invention relates to portable worklights of the type that may be mounted on a tripod or similar such support.

Portable worklights have proved useful in a variety of settings such as construction sites, industrial plants, automotive and auto body repair shops, artist and photographic studios, and around the home for do-it-yourself projects. These lights provide a high level of illumination over an extended area. In one format the lights are adapted to be set on a separate upright stand such as a tripod for greater height off the ground or work surface. The worklights of this type are formed with a support frame that is adapted to be attachable to the tripod. In some lights the support frame also forms a stand that can be set directly on the ground or other work surface in a stable position and can alternatively be mounted on a separate tripod support for greater height.

### SUMMARY OF THE INVENTION

The present invention provides a worklight having a base that is formed for holding a portable collapsible support stand (commonly referred to as a tripod) so that the stand may readily be carried, transported and stored with the worklight as a unit. Briefly, the base is formed to include a cradle that is sized and disposed to receive the support stand in its collapsed configuration. In one embodiment a continuous member such as a continuous length of tubing is bent into a framework for providing the cradle. The ends of the continuous tubing may also be formed to provide feet and the worklight head or heads may be mounted on the framework, for example, on a cross bar stretching across the feet. With a framework formed in this manner, the worklight becomes a dual-use worklight with self-contained tripod-carrying cradle. The worklight can be used as a stand-alone portable unit to be set directly on a work surface, and it can also be mounted on a tripod, and it includes a cradle for keeping the tripod with the worklight when the worklight is not being used.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is an overall view of an embodiment of a worklight according to the invention having a stand forming a tripod receiving cradle.

FIG. 2 is a perspective view of an embodiment of worklight with stand as in FIG. 1 with a tripod mounted therein.

FIG. 3 is an overall view of an alternative embodiment of the invention.

FIG. 4 is a side sectional view of the embodiment of FIG. 3.

### DETAILED DESCRIPTION OF ILLUSTRATIVE EMBODIMENTS

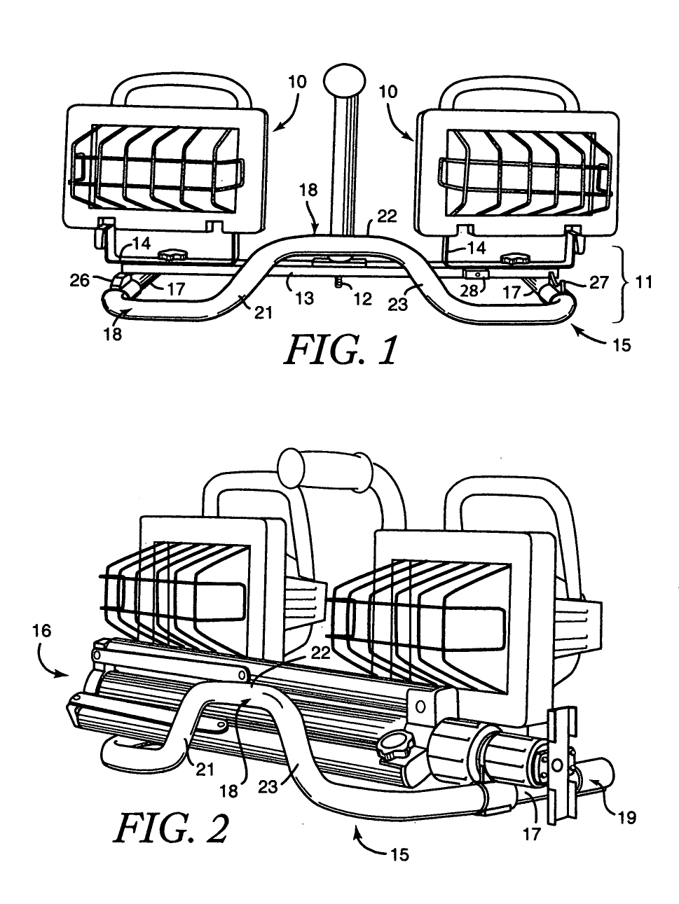

FIG. 1 shows a dual-head worklight assembly with a pair of worklight heads 10 mounted on a base 11, which is adapted at its underside to be mounted on a tripod or other elevating support stand. Such support stands are referred to generally herein as “tripods,” following common usage, although no limitation to a support stand with three legs is intended. The mounting is typically provided by a threaded stud 12 that screws into the top of the support stand, although the nature of the mounting does not play a role in the invention. A common form of support stand is a tripod with two or three telescoping sections. The particular form of the support stand (tripod) is not important here so long as it collapses into a smaller or more compact configuration for storage when the stand is not in use. Such a collapsing stand for example may simply have legs that fold in for compact carrying and storage. The collapsing stand may also have one or more extensible sections such as telescoping sections for greater height.

An electrical cord is normally connected to the worklight heads for providing power. The electrical cord has been omitted from the figures for ease of viewing.

In the embodiment of FIG. 1 base 11 includes a head support structure provided by cross bar 13 and mounting brackets 14, by which the heads 10 are mounted to cross bar 13, and also includes a framework 15, which together with the head support structure or some portion thereof, forms a cradle that is sized and disposed to receive the tripod in its collapsed configuration. FIG. 2 shows a tripod 16 in a collapsed configuration being held in the cradle.

Cradle framework 15 includes two generally parallel side members 17 that are disposed to extend under tripod 16 when the tripod is retained in the cradle. The cradle framework includes an upwardly rising front member 18 disposed to hold tripod 16 in the cradle from the front. In the embodiment illustrated in FIGS. 1 and 2 framework 15 is formed from a single continuous tubular member and the side and front members 17, 18 are provided by segments of the continuous tubular member.

In the embodiment illustrated in FIGS. 1 and 2 the ends of the tubular member run underneath head support cross bar 13 and provide feet 19 for the worklight assembly to rest on, thereby enabling the unit to be set down on the ground or on a work surface as a stand-alone unit. Following now the tubular member from one end to the other, a first end of the tubular member provides a first support foot section extending under cross bar 13. The tubular member continues to extend forward of the cross bar and generally perpendicular to the cross bar to form a first side member 17 of the cradle framework. When the tubular member has come forward a sufficient distance to fit the width of tripod 16 in its collapsed storage configuration, the tubular member turns to run generally parallel to cross bar 13 a short distance and then rises on a bias as at reference numeral 21 to a sufficient height to hold the tripod in the cradle in its collapsed configuration, continues at that height a short distance along an intermediate segment 22 and then falls as at reference numeral 23 to the level of the side members. The tubular member then continues parallel to the cross bar another short distance, and then turns to run generally perpendicular to the cross bar to form a second cradle side member 17, and extends under the cross bar to provide a second support foot section. The bias segments 21, 23 and intermediate segment 22 form the upwardly rising front member 18 that serves to hold the tripod in the cradle. While the continuous member is shown here as a one-piece tubular member, it could also be formed of several interlocking sections. Such a construction allows the cradle framework to be disassembled for example for shipping or other compact storage.

The particular shape of framework illustrated here is advantageous in that it is simple to fabricate, amenable to low-cost manufacture, and elegant in design and appearance. Nevertheless, other configurations may also be used to define the cradle. By way of example, additional members generally parallel to the side members may be used to support the support stand from underneath and thereby to define the bottom of the cradle. The upwardly rising front member need not have the biased shape shown in the figures with biased pieces on the sides, which shape is chosen for its decorative appearance. Instead, the upwardly rising front member could have vertically rising sides or curving sides. Or the upwardly rising front member may be formed only of a number of vertical posts extending upward from a horizontal footer member. These are but a few of the modifications and alternate forms of cradle framework that can be devised. The possibilities for cradle framework designs are limited only by the imagination of the designer, but all such designs are intended to fall within the spirit and scope of the broad concept of the invention.

In the embodiment of the FIG. 1 first and second plastic, tripod rest members 26 and 27 are attached to the side members 17. The tripod rests on these members when in its cradle position. Rest member 26 has an upper portion shaped to project upward so as to engage the central tripod shaft between a pair of collapsed tripod legs when the tripod is nestled in the cradle. The rest members protect the framework against scratching or other marring as the tripod is repeatedly placed in and removed from the cradle. Additionally, rest member 27 carries a concave retainer bracket on its upper face shaped to receive the neck of the tripod and hold it in position.

The cradle formation itself provides a certain amount of frictional engagement with the tripod in its storage position in the cradle that helps to maintain the tripod in the cradle and that may be assisted with other retainers such as the bracket on rest member 27. In addition, the worklight assembly may include one or more magnetic retainers. For example, in the embodiment of FIG. 1 a permanent magnet 28 is secured, for example by means of a screw, to cross bar 13. When the tripod is resting in the cradle, one of its legs runs next to magnet 28, which holds the leg, hence the tripod, in position against sliding as the worklight assembly is carried about. A magnet may also be included in the upwardly projecting portion of rest member 27 to magnetically engage and hold the tripod central shaft. Typically only a single magnet will be needed to hold the tripod against sliding, but two or more magnets could be used for greater holding power. For example, two magnets could be positioned at opposite ends of cross bar 13, particularly with larger worklight assemblies holding larger tripods. Such magnetic retainers are convenient to use with a tripod made of steel or other magnetically responsive ferromagnetic material. But other forms of nonmagnetic retainers can also be used, for example, releasable clasps or stops or even one or more flexible fabric or synthetic straps with hook and loop fasteners or buckles.

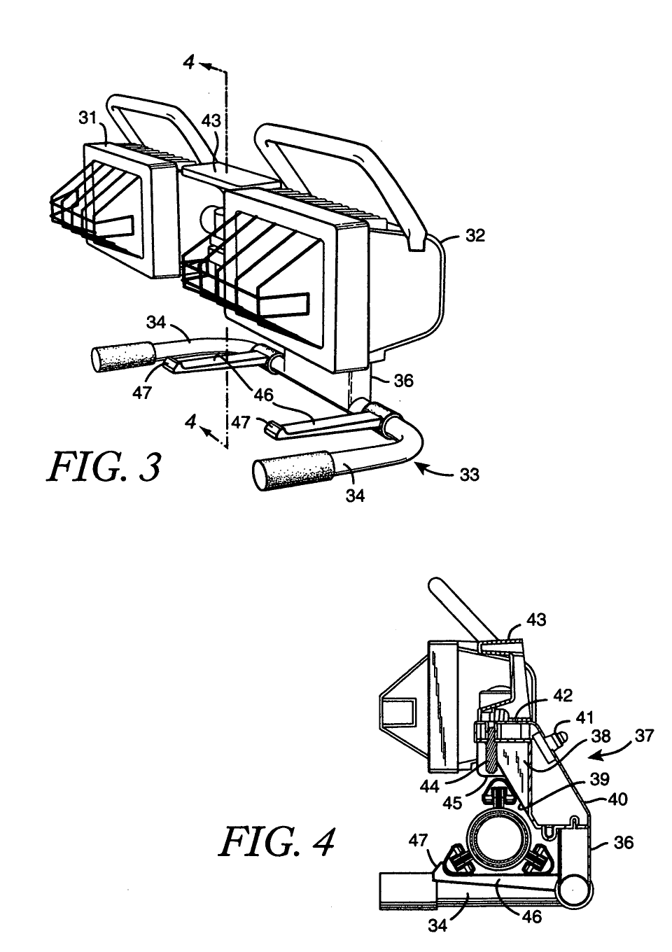

FIG. 3 shows an alternative embodiment of worklight assembly with two worklight heads 31 and 32 and with a base that does not have an upwardly extending front portion as part of the main framework for retaining the tripod. The base in the embodiment in FIG. 3 includes a generally U-shaped tubular framework member 33 that has two side leg sections 34 that extend under the tripod when the tripod is mounted in the cradle. At the central portion of framework member 33 is a substantially vertical section 36 forming part of the head support structure. An angled section, indicated generally at reference numeral 37 is inclined forward from vertical section 36 and includes two portions 38, one adjacent each head, and each providing an inclined tripod-retaining surface 39 defining a back surface of the cradle for retaining the tripod in the cradle. FIG. 4 shows a cross-sectional view of this embodiment taken along the medial plane indicated by line 4-4 in FIG. 3. Thus, in the view of FIG. 4 the head 32 has been removed to expose a central support compartment 40, shown in cross section, that holds a switch 41 and associated wiring for turning on the lights. The wiring and electrical cord have been omitted from the figures for clarity. Support compartment 40 is formed at its upper end with a horizontal extension 42. Mounted on top of extension 42 is handle 43. Extension 42 also holds a downwardly extending stud 44 that is used to mount the worklight assembly on a tripod. Stud 44 is comparable to stud 12 in the embodiment of FIG. 1. In the view shown in FIG. 4 the first portion 38 of the angled section defining the first inclined tripod-retaining surface 39 next to head 31 lies behind central support compartment 40. A second such portion lies next to compartment 40 adjacent head 32, but is not present in the cross-sectional view of FIG. 4. The inclined surfaces 39 engage at least one of the legs of the collapsed tripod when it is set in the cradle. FIG. 4 illustrates a three-legged tripod with a collapsed configuration in which the legs are disposed symmetrically about the central tripod shaft to form a generally equilateral triangular profile. Surface 39 is seen to engage the top leg, and the angle of inclination is roughly 30 degrees from the vertical so as to follow one side of the generally equilateral triangular profile of the tripod as it rests in the cradle. In other embodiments the inclined side could extend to engage two legs of the tripod in the cradle. The inclined portions 38 also carry a member defining a substantially horizontal tripod-retaining surface 45 for retaining the tripod in the cradle from above.

When the worklight assembly is mounted on a fully extended vertical tripod, the top of the tripod reaches up between the two portions 38 so that stud 44 can be screwed into the top of the tripod.

Framework 33 carries two latching members 46 for holding the tripod in the cradle from the front. Members 46, in the form of linear arms, are secured at the back of framework 33 and extend under the tripod. The members 46 are formed at their forward ends with an upwardly extending stop 47 that holds the tripod against forward movement for retaining the tripod in the cradle. The mechanical retaining stop 47 of this embodiment is an alternative to the magnetic retainer 28 shown in FIG. 1, although a magnetic retainer may also be used in the embodiment of FIGS. 3 and 4, which embodiment can also be configured with a magnetic retainer instead of the mechanical latching members 46. FIG. 4 shows a tripod nestled in position in the cradle. In the disclosed embodiment the linear arms of members 46 are at the same level as the top of legs 34 of the framework, and the arms are formed to have a small degree of flex so that the tripod is able to urge the tabs 47 downward slightly, if need be, as the tripod is slipped into the cradle position.

The above descriptions and drawings are given to illustrate and provide examples of various aspects of the invention in various embodiments. It is not intended to limit the invention only to these examples and illustrations. Given the benefit of the above disclosure, those skilled in the art may be able to devise various modifications and alternate constructions that although differing from the examples disclosed herein nevertheless enjoy the benefits of the invention and fall within the scope of the invention, which is to be defined by the following claims. Any limitation in the claims not expressly using the word “means” is not intended to be interpreted as a “means plus function” limitation in accordance with Title 35, United States Code, Section 112, and any claim limitation expressly using the word “means” is intended to be so interpreted.

1. In a worklight assembly including at least one worklight head mounted on a base, the base being mountable on a support stand and the support stand having a collapsed configuration for storing the support stand when not in use, the improvement characterized in that:
said base forms a cradle sized and disposed to receive said support stand in said collapsed configuration.

2. The worklight assembly of claim 1 wherein said cradle comprises at least two generally parallel side members disposed to extend under said support stand when retained in said cradle and at least one upwardly rising front member disposed to retain said support stand in said cradle.

3. The worklight assembly of claim 2, further comprising a continuous member wherein said side and front members are provided by segments of said continuous member.

4. The worklight assembly of claim 3 wherein said side members are further formed to provide first and second legs for supporting said worklight assembly on a work surface and said continuous member further has a central section running between said first and second side members and formed so that at least a portion thereof provides said at least one upwardly rising front member.

5. The worklight assembly of claim 1, further comprising at least one retainer for holding said support stand in said cradle.

6. The worklight assembly of claim 5 wherein said at least one retainer comprises a magnet disposed for magnetically holding said support stand in said cradle.

7. The worklight assembly of claim 1 wherein said base includes at least two generally horizontally extending side legs for supporting said support stand in said collapsed configuration from underneath.

8. The worklight assembly of claim 7, further comprising at least one latching member formed and disposed to engage said support stand in said collapsed configuration, said latching member including a mechanical stop for holding said support stand in said cradle.

9. The worklight assembly of claim 7 wherein said support stand has three legs generally symmetrically disposed about said support stand in said collapsed configuration, and wherein said base includes a portion inclined with respect to said generally horizontally extending side legs so as to engage at least one of said support stand legs when said support stand is in position supported on said two generally horizontally extending side legs.

10. A worklight assembly including at least one worklight head mounted on a base, the base being mountable on a support stand and the support stand having a collapsed configuration for storing the support stand when not in use, comprising:
a cross bar wherein said at least one worklight head is mounted on said cross bar;
a continuous linear framework having end sections extending under and supporting said cross bar, said framework being formed to support said support stand in its collapsed configuration from underneath and being formed with an upwardly extending front portion for retaining said support stand between said cross bar and said front portion.

11. The worklight assembly of claim 10, further comprising at least one magnet secured to said assembly in a disposition to retain said support stand in position on said worklight assembly in said collapsed configuration.

12. The worklight assembly of claim 11 wherein said at least one magnet is secured to said cross bar.

13. In a worklight assembly including at least two worklight heads mounted side by side on a base, the base being mountable on a collapsible support stand having a collapsed configuration for storing the support stand when not in use, the improvement comprising:
means for mounting said support stand in said collapsed configuration on said worklight assembly for carrying or storing said support stand with said worklight assembly, said means forming a part of said base.
